(19) United States
(12) Patent Application Publication
(10) Pub. No.: US 2020/0060237 A1
(43) Pub. Date: Feb. 27, 2020

(54) RETRACTABLE LEASH WITH INTEGRATED POOPER SCOOPER AND BAG MANAGEMENT SYSTEM

(71) Applicant: Kerley Prudhomme, Silver Spring, MD (US)

(72) Inventor: Kerley Prudhomme, Silver Spring, MD (US)

(21) Appl. No.: 16/543,707

(22) Filed: Aug. 19, 2019

Related U.S. Application Data
(60) Provisional application No. 62/722,984, filed on Aug. 27, 2018.

(51) Int. Cl. A01K 27/00; A01K 23/00; B65H 75/02

(52) U.S. Cl. CPC A01K 27/004; B65H 2701/191; B65H 75/02; A01K 23/005

(57) ABSTRACT

A retractable leash with integrated pooper scooper and bag management system, which provides a leash retractor, pooper scooper and bag dispenser that can be used to pickup bio-waste while walking domesticated pets, and method therefor. Components of the invention are the leash body shells, leash line, leash line hold button, pooper scooper scoops, scoop lever, scoop lever lock button, bag roll and bag clips, which, generally speaking, are configured as follows: the pooper scooper is connected to the bottom of the leash body shells, the scoop lever is located at the top of leash body with a lock button, the leash line is controlled by the leash line hold button located at the top of the invention, bag roll is located within the leash body shells and dispensed from either side of the invention. Bag clips are connected on both sides of invention to secure bag ends. The invention is used to leash and control pet distance from the pet owner during walks. In addition, the invention allows the owner to pick up and secure pet bio-waste, without the pet owner physically feeling the waste with their hands, at any time before, during or after the walk. Furthermore, the invention includes a reloadable bag dispenser system with door to install and secure bag roll within the device body.

### RELATED PATENT APPLICATION

The present application is a non-provisional of U.S. Provisional Patent Application Ser. No. 62/722,984, filed Aug. 27, 2018, entitled “RETRACTABLE LEASH WITH INTEGRATED POOPER SCOOPER AND BAG MANAGEMENT SYSTEM,” the disclosure of which is incorporated herein by reference.

### BACKGROUND OF THE INVENTION

### Field of the Invention

The invention relates generally to retractable leash with integrated pooper scooper and bag management system.

### Background

Currently there are a number of solutions for retractable leash mechanism containing a pet waste management device. Some of these solutions attempt to add a standalone roll of pet waste bags to a ring collar hanging off the retractable leash, but these solutions fail to meet the needs of the industry because such solutions still require the pet owner, or user, to touch and feel the warm pet bio-waste with hands when picking up after their pets. Other solutions attempt to combine waste bags with pooper scooper, but these solutions are similarly unable to meet the needs of the industry because they do not provide a method for the pet owner to lock and positively secure the bag within scoops after pick-up possibly resulting in pet bio-waste exiting scoops during transport to trash receptacle. Still other solutions seek to combine waste bags with pooper scooper, but these solutions also fail to meet industry needs because they do not provide a means to control the leash line while walking pets.

It would be desirable to have a retractable pet leash product that provides more than one function of controlling the length of a lease line. Furthermore, it would also be desirable to have a retrieval mechanism for bio-waste pick-up keeping pet owner from touching pet bio-waste.

Moreover, it would be beneficial to be able to lock the scoops during pet walking period to avoid accidentally spills while perform multiple pet bio-waste pickups with the same bag. Still further, it would be desirable to have a means to reload pre-packaged bag rolls into the leash body and secure in place using built-in bag roll door.

Therefore, there currently exists a need in the industry for a retractable pet leash with integrated pooper scooper and bag management system for pet waste pick-up.

### SUMMARY OF THE INVENTION

The invention advantageously fills the aforementioned deficiencies by providing a method of reducing the number of devices needed to walk a pet and pick-up and dispose of pet waste all within one product.

Disclosed is a retractable leash with integrated pooper scooper and bag management system, which is made up of the following components: left and right leash body shells, a bolt snap with swivel eye, a leash line, a leash line lock pin, a leash line hold button, a leash line exit bushing, a pulley, a constant force spring, left and right pooper scooper scoops, a scoop lever, a scoop lever lock button, compression springs, two (2) tie rods, bag roll, bag roll door with opening, two (2) bag clips, two (2) logo stickers and metal screws.

These components are preferably connected as follows: the pooper scooper is connected to the bottom of the leash body shells, the scoop lever is located at the top of leash body with a scoop lever lock button and bag dispenser is located within the leash body shells and bag clips located on both sides of invention to secure bag ends. The leash line is connected to the pulley used to dispense and wind the leash line. The pulley is also connected to the constant force spring used to release or exert force on pulley. The constant force spring is connected to both leash body shells by a protruding boss with a slit to hold the constant force spring. The scoop level lock button is connected to the scoop lever controlling its actuation. A compression spring is connected to the center section of the scoop lever. The tie rods are connected to the rear of the scoop level and pooper scooper scoops. The scoops open when scoop level is depressed and the scoops close when the scoop lever is released.

The device may also have one or more of the following: (1) an extremely light adhesive surface inside the pooper scooper scoops for added adhesion for the bio-waste bags when dispensed into scoops; (2) a reflective strip on the leash line material and/or along the device for added safety during nighttime walks; (3) a flashlight added to the front of the invention to be used to guide pet owner and pet during nighttime walks; and (4) an LED bar added to the underside of the retractable leash body, inside the interior of the pooper scooper scoops, to illuminate the ground when the scoops are opened to aid in waste pick-up during nighttime walks.

The disclosed device is unique when compared with other known devices and solutions because it provides: (1) a multifunctional solution while reducing material volume of similar devices combined; (2) a barrier eliminating the user's contact with warm pet waste; and (3) provides the user with means of discreetly carrying pet waste.

The disclosed device is unique in that it is structurally different from other known devices or solutions. More specifically, the device is unique due to the presence of: (1) an integrated pooper scooper and bag management system that creates a streamlined profile that possesses a more compact design when compared to standalone components; (2) enhanced control and function of scoops using spring-loaded scoop lever; and (3) provides the user, or pet owner, with a locking mechanism to secure and prevent the scoops from opening if the scoop lever were accidentally depressed.

It is still further an objective of the present invention to create a device that is more economical to produce, easier to manufacture, easier to use and more durable.

Further still, it is an objective of the present invention to create a device that is smaller and more lightweight than other solutions, thereby enabling the device to be more easily portable.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 shows a perspective right-side view of retractable leash with integrated pooper scooper and bag management system;

FIG. 2 shows a perspective exterior view of retractable leash with integrated pooper scooper and bag management system;

FIG. 3 shows a perspective view of retractable leash with left body shell removed showing internal components;

FIG. 4 shows a simple view of bolt snap clip with swivel eye and leash line attachment; and

FIG. 5 shows side views of the primary scoop profile and three scoop profile variations.

### DETAILED DESCRIPTION

This disclosure will now provide a more detailed and specific description that will make reference to the accompanying drawings. The drawings and specific descriptions of the drawings, as well as any specific or alternative embodiments discussed, are intended to be read in conjunction with the entirety of this disclosure. The retractable leash with integrated pooper scooper and bag management system may, however, be embodied in many different forms and should not be construed as being limited to the embodiments set forth herein; rather, these embodiments are provided by way of illustration only and so that this disclosure will be thorough, complete and fully convey understanding to those skilled in the art.

As noted, the present invention is directed to a retractable leash with integrated pooper scooper and bag management system and assembly, as set forth in various embodiments described in detail hereinbelow and depicted in the various FIGURES of the DRAWINGS.

In a first embodiment, the device is preferably made up of the following components: right leash body shell; left leash body shell; a bolt snap clip with swivel eye; leash line termination block; a leash line exit bushing, a leash line with reflective webbing; a leash line lock pin; a pulley; a constant force spring; a leash line hold button; left pooper scooper scoop with light interior adhesive; right pooper scooper scoop with light interior adhesive; four (4) scoop pivot pins; two (2) tie rods; a scoop lever; a scoop lever lock button; a compression spring for the leash line hold button; a scoop level compression spring; bag roll; a bag roll door; right bag clip; left bag clip; right logo sticker; left logo sticker; metal fastening hardware; a flashlight; and LED bar.

These components are preferably connected as follows: the pooper scooper scoops are connected to the bottom of the leash body shells, the scoop lever is located at the top of leash body shells with a scoop lever lock button to ensure scoop lever cannot be depressed unintentionally and bag roll is located within leash body shells in the middle of the device. An LED bar is located on the underside of the retractable leash body inside the interior of the pooper scooper scoops to illuminate the ground when the scoops are opened to aid in waste pick-up during nighttime walks.

The bolt snap clip is connected to the far end of the leash line, the opposite end of the leash line is connected to the pulley, secured in place by a leash line lock pin, used to dispense and wind leash line. The pulley is connected to both leash body shells through a boss that is connected to constant force spring to release or exert force on pulley. The bag dispensing mechanism contains a bag roll that is used to extract a bag and place over scoops to create the barrier between the scoops and pet bio-waste.

Once bio-waste is collected in scoops, the end of the bag is twisted to gather bag end and then inserted in one of the two (2) bag clips residing on each side of the device. The additional components that reside internally of the invention consists of pivot pins, two (2) tie rods and compression spring.

It should be understood that the pulley can be manufactured out of various materials, including, but not limited to, aluminum, steel, titanium, wood, acrylic, acrylonitrile butadiene styrene (ABS), polypropylene (PP), polycarbonate (PC), polyethylene (PE) or polyethylene terephthalate (PET) plastics for reliability and integrity. This part is preferably created via methods such as, but not limited to, injection molding, tool milling or 3D printing to create repeatable manufactured components with tight tolerances.

The aforementioned constant force and compression springs are preferably made of spring steel such as, but not limited to, low-alloy Manganese, medium-carbon steel or high-carbon steel which allows them to return to their original shape despite repeatable cycles and allowable deflection. The leash line lock pin, tie-rods, bolt snap clip with swivel eye and metal fastener hardware, are preferably made of metals such as, but not limited to, steel, high-carbon steel, rigid plastics, high-alloy aluminum, titanium or brass which allows them to remain rigid while avoiding deflection and structural reliability over repeatable cycles and stress. The metal fastening hardware can be manufactured in a form such as, but not limited to, screws, bolts, nuts, press pins, rivets, etc.

It should further be noted that the leash body shells, pooper scooper scoops, scoop lever, scoop lock button, leash line exit bushing, leash line hold button, scoop level lock button, bag roll door and bag clips are preferably manufactured out of material such as, but not limited to, acrylonitrile butadiene styrene (ABS), acetal, polypropylene (PP) or polyvinyl chloride (PVC) plastics for reliability and integrity. These parts are created via methods such as, but not limited to, injection molding, tool milling or 3D printing to create repeatable manufactured components with tight tolerances. These parts can be any color such as, but not limited to, red, blue, green, black, pink, yellow or impregnated with pigments to achieve alternate color schemes and/or patterns.

The leash line can be manufactured in a form such as, but not limited to, a string, rope, strap, webbing or flexible pipe from material such as, but not limited to, nylon, polyester, Kevlar, hybrid plastic/steel line or other synthetic material to create a strong and long-lasting component to ensure reliability and strength while force is being applied to material. The bag roll is manufactured out of material such as, but not limited to, polyethylene (PE) plastics or similar plastics with optional green pigments and/or dark-colored perforated line to provide indication of bag separation. To further aid in securing bags to scoop, extremely light pressure-sensitive adhesive (PSA) or rubber cement is applied to inside of the scoops to aid with bags being placed on pooper scooper surfaces for bio-waste pick-up. The light PSA ensures the bag makes intimate contact with inside of scoop creating a maximized void for bio-waste pickup.

The leash line termination block can be made from various material like, but not limited to, plastic, metal, fiberglass, etc. The bolt snap clip with swivel eye can be substituted with optional locking mechanisms like carabiners, screw link, lanyard clasp hooks, clip hooks, D-ring, snap hook, etc. allowing attachment to both leash line and pet leash collar located on pet.

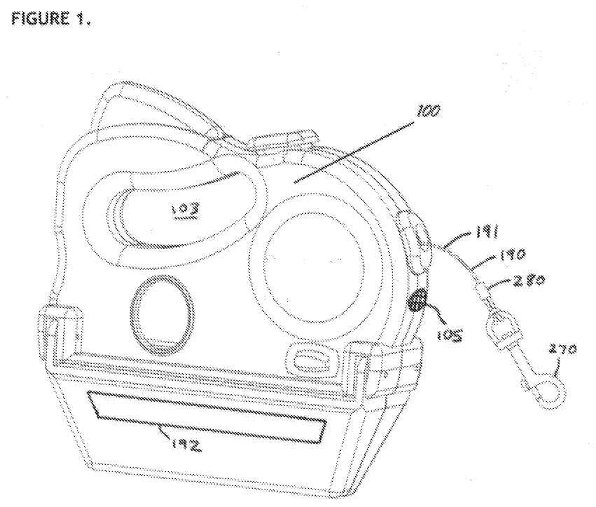

With reference now to FIGS. 1, 2 and 3 of the DRAWINGS, the diagrams shown illustrate perspective views of a retractable leash with integrated pooper scooper and bag management system, generally designated by the reference numeral 100, in FIG. 1 a right side configuration perspective shown, in accordance with an exemplary embodiment of the invention.

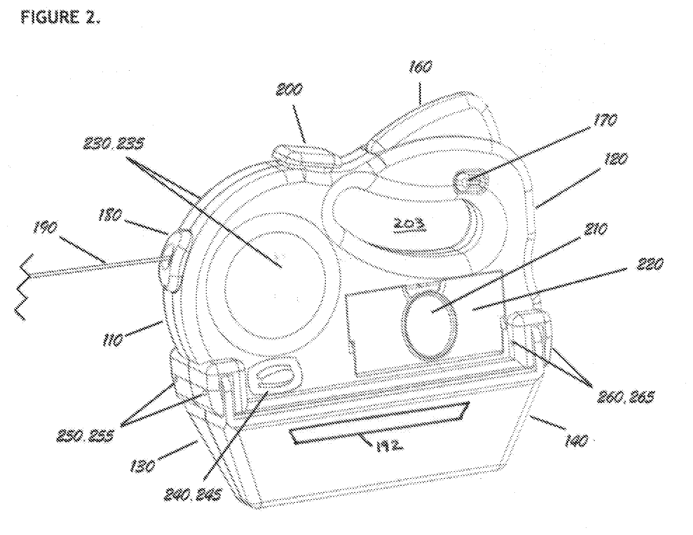

With reference now to FIG. 2, the retractable leash with integrated pooper scooper and bag management system 100 in a left side perspective configuration. In further reference to FIG. 2, the system 100 includes a right leash body shell 110, a left leash body shell 120, a right scoop 130, a left scoop 140, a scoop lever 160, a scoop lever lock button 170, a leash line exit bushing 180, a leash line 190, a leash line hold button 200, a bag roll 210, a bag roll door 220, two (2) logo stickers 230 and 235, one on either side of the system 100 shown, two (2) bag clips 240 and 245, one on either side of the system 100 shown, and four (4) pivot pins 250, 255, 260 and 265.

With reference now to FIGS. 1-4, there are also shown a snap bolt clip 270 and a leash line termination block 280, which are shown attached to the system 100 in FIG. 1. Further shown are a pulley 300, a constant force spring 310, a leash line lock pin 320, a compression spring 330 for the aforementioned leash line hold button 200, a compression spring 340 for the aforementioned scoop lever 160, two (2) tie rods 350 and 355, and metal fastener hardware, generally designated by the reference numerals 360, 365, 370 and 375.

By way of example, the opening in the right leash body shell 110 and left leash body shell 120 may be substantially curved and elliptical in shape in order to accommodate the hand of the pet owner. In one particular and illustrative, yet non-limiting, embodiment, the right leash body shell 110 and left body shell 120 may at their widest section have a width of approximately or about 2.0 inches, e.g., 1-3 inches, 1.5-2.5 inches, or 1.8 to 2.2 inches, preferably at their longest section have a length of about 6.75 inches, e.g., 5-8 inches, 6-7.5 inches, or 6.5-7 inches, and at their tallest section have a height of about 6.5 inches, e.g., 5-8 inches, 6-7 inches, or 6.25-6.75 inches.

The leash line 190 may have various lengths such as, but not limited to, 6, 8, 10, 12, 14, 16 feet, etc.

Of course, these measurements are merely illustrative and components of any width and any length and any height that include the features described herein are intended to be within this disclosure and make up the overall invention, which has many different embodiments.

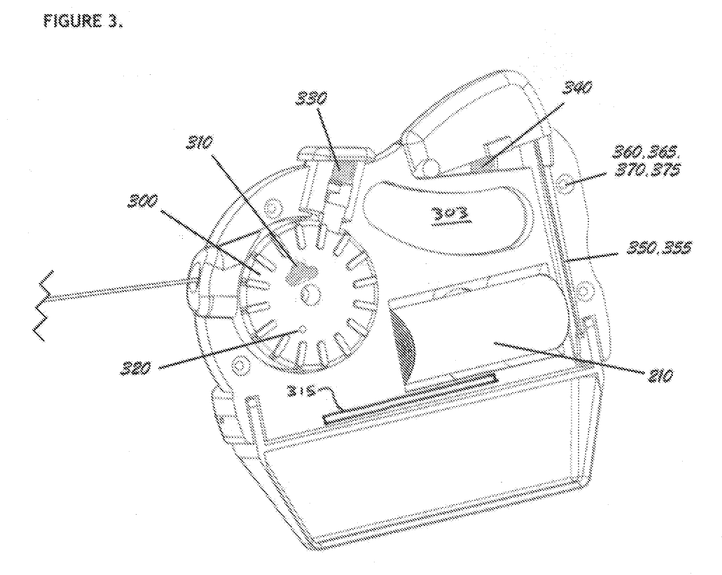

With more specificity there is described a particular configuration of the present invention, where the retractable leash with integrated pooper scooper and bag management system 100 includes the aforesaid constant force spring 310 (shown in FIG. 3) connected to pulley 300 (also shown in FIG. 3).

The looped end of the leash line 190 (shown in FIGS. 2 and 3) is connected and secured to the pulley 300 (shown in FIG. 3) by the aforedescribed leash line lock pin 320 (also shown in FIG. 3). The open end of the leash line 190 is feed through the leash line bushing 180 (shown in FIGS. 1 and 2) and the leash line bushing 180 is installed in the right leash body shell 110 (shown in FIG. 2).

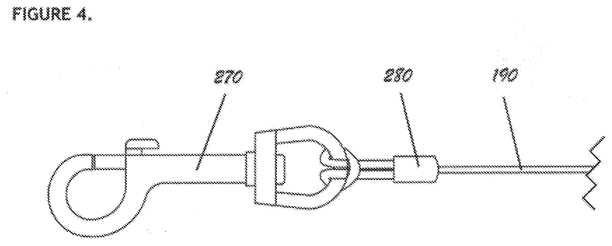

The snap bolt clip 270 (shown in FIG. 4) is connected at the opposite end of the leash line 190. The constant force spring 310 is wound to create some resistance before the aforesaid pulley 300 is placed inside the right leash body shell 110. The compression spring 330 (shown in FIG. 3) is inserted into the bottom of the leash line hold button 200 (shown in FIG. 2) and secured in place via a press fit. The leash line hold button 200 is located and placed in the appropriate walled slot of the right leash body shell 110 and against the pulley 300.

The compression spring 340 (shown in FIG. 3) is inserted into the bottom of the scoop lever 160 (shown in FIG. 3) and secured in place via press fit. The scoop lever 160 is located and placed in the appropriate walled slot of the right leash body shell 110. The right scoop 130 (shown in FIG. 2) is inserted into the bottom side of the right leash body shell 110, aligned and secured in place by two (2) pivot pins 250 and 260 (shown in FIG. 2) that are press-fitted into the pre-existing hole located at the bottom of the right leash body shell.

An open end of the tie rod 350 (shown in FIG. 3) is inserted in the right-most hole at the bottom of the scoop lever 160 and the opposite end is attached to the right scoop 130. The left scoop 140 (shown in FIG. 2) is inserted into the bottom of the left leash body shell 120, aligned and secured in place by two (2) pivot pins 255 and 265 (shown in FIG. 2) that are press-fitted into the pre-existing hole located at the bottom of the left leash body shell.

The scoop lock button 170 (shown in FIG. 2) is installed through the interior open slot located near the handle of the left leash body shell 120. An open end of the tie rod 355 (shown in FIG. 3) is inserted in the left-most hole at the bottom of the scoop lever 160 and the opposite end is attached to the left scoop 140. The left leash body shell 120 is installed over the right leash body shell 110 and secured in place using metal fastening hardware 360, 365, 370 and 375 (shown in FIG. 3).

The bag roll 210 (shown in FIG. 3) is inserted into the large opening located at the bottom of the left leash body shell 120. The bag roll door 220 (shown in FIG. 2) is inserted into the exterior side of large opening of the left leash body shell 120. The logo stickers 230 and 235 (shown in FIG. 2) are placed over the circular raised surface found on the exterior of both the right and left leash body shell 110 and 120, respectively.

Referring now to FIG. 4, the diagram shown illustrates a simple view of the aforementioned bolt snap clip with swivel eye 270 and leash line 190. The leash line 190 is folded onto itself, the loop in the leash line is inserted through the swivel eye of the bolt snap clip 270, the loose end of the leash line is 190 is inserted through the open loop of leash line and secured tightly by pulling firmly on the leash line 190. The short free end of the leash line 190 is secured to the longer portion of the leash line by using the aforesaid leash line termination block 280, as shown in FIG. 4.

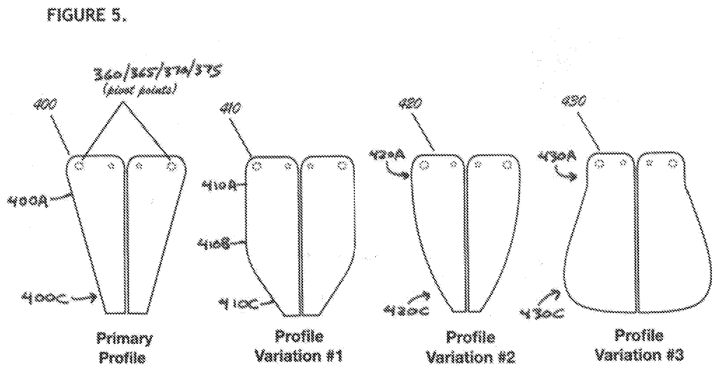

With reference now to FIG. 5 of the DRAWINGS, the diagram shown illustrates side views of the primary scoop profile and three (3) alternative scoop profile variations. As is understood, the aforesaid scoop profile is along a longitudinal axis of the device 100. Primary profile 400 is representative of the disclosed device, as described in more detail hereinabove. This profile is optimal for waste pick-up without making the scoop too large for the thickness of the device 100 and ensures positive pressure on bio-waste for pick-up.

In particular, profile 400 is broad at the top portion, generally designated by the reference identifier 400A, while tapering steadily down to a narrow bottom portion 400C.

With further reference to FIG. 5, the second profile variation #1, generally designated by the reference numeral 410, illustrates an alternative scoop contour for the disclosed device. For example, profile 410 shows a narrow bottom portion for small volume pickup. The profile 410 is broad at the top 410A and middle portion, designated by the reference identifier 410B, with an abrupt taper transition to the bottom portion 410C.

Profile variation #2, generally designated by the reference numeral 420, illustrates another alternative scoop contour for the disclosed device of the present invention. The profile 420 shows a smoother contour from a top portion 420A of the scoop down to the bottom portion 420C of the scoop, i.e., the profile 420 is broad at the top portion 420A with a gradual taper transition to the bottom portion 420C.

Finally, profile variation #3, generally designated by the reference numeral 430, illustrates still another alternative scoop contour for the disclosed device. The profile 430 shows a wider bottom portion 430C for large volume pickup. The profile is broad at the top portion 430A with a gradual outward taper transition to the bottom portion 430C.

With reference again to FIG. 1 of the DRAWINGS, there is illustrated additional preferred features of the present invention. For example, to better serve the purpose of pet device being used at night, a flashlight, generally designated by the reference numeral 105 can be employed to illuminate the area. It should be understood that the power source for the flashlight, e.g., batteries, are positioned adjacent the flashlight 105 and within the shell body, i.e., inside the conjoined right 110 and left 120 leash body shell components, as shown in the Figures.

With reference to FIGS. 1-3, the aforedescribed scoop lever 160 is located in a raised configuration, where the user of the device 100 employs their palm to activate the scoop lever 160, e.g., by depressing the lever 160 with their hand.

In an alternate configuration, the scoop lever 160 location would be placing the scoop lever inside the opening of the invention body, generally designated by the reference numeral 103/203/303, requiring the fingers of the user, as opposed to their palm, to squeeze around the invention handle, located on top of the invention, resulting in an upward depressing motion of the scoop level if invention body were stationary, which would be similar in configuration and positioning to the aforesaid scoop lever lock button 170. It should be understood that depressing the scoop lever 160 in this particular configuration would result in the same articulation of the two (2) tie rods 350/355 attached to the scoop 130 and 140 because the scoop lever 160 would possess a midpoint pivot point within the invention body alternating the direction of movement, creating a downward motion, on the tie rod end of the scoop lever 160 similar to the original configuration, set forth in more detail hereinabove. Additionally, this configuration, placing the scoop lever 160 inside the handle opening area 103/203/303, results in the user pulling up on the lever 160 instead of pushing down as in the earlier configuration described hereinabove.

Also with reference to FIG. 3, there is illustrated the aforementioned LED bar, generally designated by the reference numeral 315, which is affixed inside the shell body 110 and 120, and configured to illuminate the ground and the object to pick up, such as feces. As with the flashlight 105, the power source or sources for both devices are within the shell body 110 and 120. In a preferred embodiment, the LED bar 315 only lights up when the scoops 130 and 140 are open, e.g., automatically, thereby aiding in waste pickup in the dark.

With reference now to FIG. 3, the LED bar 315 is added to the bottom-side exterior of the retractable leash body 110 and 120, inside the interior of the pooper scooper scoops 130 and 140, to illuminate the ground when the scoops are opened to aid in waste pick-up during nighttime walks. The LED lighting arrangement preferably consists of a LED bar, at least one lithium battery, two (2) magnetic charging plates, a small control board, an on/off switch and various wiring. As shown, the LED bar 315 is located in between the bottom exterior surfaces of the right and left leash body shells 110 and 120 and connected to the aforementioned lithium battery, via the wiring, located within the invention body. The lithium battery is connected, via wiring, to a small control board used to regulate the battery charging.

The control board in this configuration is connected, via wiring, to both an on/off switch, located at either the front or rear of the leash body 110 and 120 near the pivot points 260/265 of the scoops 130 and 140 for activation, and magnetic charging plates use to produce an inductive charge for the lithium battery when the aforesaid pulley 300 rotates. One magnetic plate containing wiring is affixed to either the right or left leash body shell and the other magnetic plate not containing wiring is affixed to respective side of the pulley 300. As the pulley 300 rotates, the differential between the electromagnetic field creates a charge running thru wires to small control board and then fed to battery as needed.

Also, since safety is a major concern, especially at night, the present invention includes additional features to alert those nearby, perhaps passing motorists, of the presence of the user and their pet. For example, the leash 190 material may include a variety of reflective portions to heighten the awareness of others, generally designated by the reference numeral 191. Also, the pet device 100 can also include reflective strips along the sides thereof, such as along the scoop apparatus, generally designated by the reference numeral 192.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A pet device, comprising:
a shell body;
a leash, said leash capable at one end of attaching to a pet, and said leash at a second end thereof attached to a retraction mechanism within said shell body;
a scoop apparatus, said scoop apparatus having a left scoop and a right scoop, and attached at an upper portion thereof to a lower portion of said shell body, said left scoop and said right scoop along said upper portion being connected to a plurality of pivots;
a scoop lever attached to an upper portion of said shell body and connected to said scoop apparatus,
wherein, when said scoop lever is activated, said left scoop and said right scoop pivot along said plurality of pivots to an open configuration along a lower portion of said scoop apparatus, said scoop apparatus in said open configuration being capable of covering an object on the ground; and
a bag assembly, said bag assembly having a store of bags therein, said bag assembly being within said shell body with an opening therethrough, whereby a user can retrieve a bag therefrom,
wherein said bag retrieved by said user is capable of being deployed substantially around said pet device, forming a barrier between the pet device and the object,
wherein, after positioning said scoop apparatus in said open configuration over said object, with said bag deployed around said pet device, engaging the scoop lever closes the left scoop and right scoop, encapsulating the object within said bag and within said scoop apparatus.

2. The pet device according to claim 1, wherein said shell body comprises a left shell body and a right shell body.

3. The pet device according to claim 2, wherein said left shell body and said right shell body are secured together by a plurality of fasteners

4. The pet device according to claim 1, wherein said retraction mechanism comprises a pulley and at least one compression spring.

5. The pet device according to claim 4, further comprising:
a leash hold button, wherein, upon activation, said leash hold button engages said at least one compression spring to stop said pulley, holding said leash in place.

6. The pet device according to claim 1, further comprising:
a scoop lever lock button;
a plurality of tie rods connected to said scoop lever lock button; and
a compression spring, said compression spring connected to said scoop lever lock button,
wherein, upon activation of said scoop lever lock button, said plurality of tie rods holds the left scoop and the right scoop of the scoop apparatus in place.

7. The pet device according to claim 1, further comprising:
at least one bag clip along a side of said shell body,
wherein, after encapsulation of said object in said bag in said scoop apparatus, said user is capable of twisting an end of said bag closed, opening said scoop apparatus, and inserting said end of said bag in said at least one bag clip.

8. The pet device according to claim 7, wherein, after said insertion of said bag in said at least one bad clip, the user can dispose of the bag by removing the bag from the at least one bag clip and from the pet device.

9. The pet device according to claim 8, wherein, after disposing of the bag by the user, the user is capable of deploying another bag from said store of bags of said bag assembly.

10. The pet device according to claim 1, further comprising:
an LED, said LED being configured within said scooper apparatus and affixed to the lower portion of said shell body,
wherein said LED, when said scooper apparatus is in said open configuration, is automatically activated, thereby illuminating the object and the ground underneath the pet device.

11. The pet device according to claim 1, further comprising:
at least one reflective strip.

12. The pet device according to claim 11, wherein said at least one reflective strip is on the leash, sides of the pet device or combinations thereof.

13. The pet device according to claim 1, wherein a scoop profile of said scoop apparatus from the top portion tapers therefrom to a narrower configuration at the bottom portion thereof.

14. The pet device according to claim 1, wherein a scoop profile of said scoop apparatus from the top and middle portions tapers from the middle portion to a narrower configuration at the bottom portion thereof.

15. The pet device according to claim 1, wherein a scoop profile of said scoop apparatus from the top portion curves therefrom to a narrower configuration at the bottom portion thereof.

16. The pet device according to claim 1, wherein a scoop profile of said scoop apparatus from the top portion curves outward and then inward therefrom to a wider configuration at the bottom portion thereof.

17. The pet device according to claim 1, further comprising:
a flashlight configured at a front portion of said pet device.

18. The pet device according to claim 1, wherein a plurality of components of said pet device are made of compositions selected from the group consisting of acrylonitrile butadiene styrene (ABS), acetal, polypropylene (PP), polyvinyl chloride (PVC) plastics and combinations thereof.

19. The pet device according to claim 1, wherein said shell body has a configuration with a width dimension selected from the group consisting of about 1-3 inches, about 1.5-2.5 inches, about 1.8 to 2.2 inches and about 2.0 inches,
wherein said shell body has a configuration with a length dimension selected from the group consisting of about 5-8 inches, about 6-7.5 inches, about 6.5-7 inches, and about 6.75 inches, and
wherein said shell body has a configuration with a height dimension selected from the group consisting of about 5-8 inches, about 6-7 inches, about 6.25-6.75 inches, and about 6.5 inches.

20. A method for bagging waste product of a pet using a pet device comprising:
removing a bag from within a bag assembly, said bag assembly within a shell body of said pet device;
opening a scoop apparatus attached to said shell body, said scoop apparatus having a left scoop and a right scoop to capable of opening to an open configuration, said scoop apparatus having a cavity within when in said open configuration;
deploying said bag substantially around said pet device and within said cavity, the closed end of said bag within said cavity;
positioning said pet device over a waste object on the ground and within said cavity;
closing said scoop apparatus with said waste object within said bag and within said cavity;
removing said bag from around said pet device, said closed end of said bag fixed within said cavity of said scoop apparatus, the open end of said bag capable of being twisted closed by a user;
securing a twisted end of said bag in a bag clip within said shell body; and
dropping said bag with said waste object therein, after opening said scoop apparatus to said open configuration, into a waste receptacle.
